(19) United States
(12) Patent Application Publication
(10) Pub. No.: US 2010/0318249 A1
(43) Pub. Date: Dec. 16, 2010

(54) VEHICLE AND CONTROL METHOD THEREOF

(75) Inventors: Kunihiko Jinno, Toyota-shi (JP); Tadashi Nakagawa, Nishikamo-gun (JP); Masahiko Maeda, Nagoya-shi (JP); Hideaki Yaguchi, Toyota-shi (JP)

Correspondence Address: SUGHRUE MION, PLLC, 2100 PENNSYLVANIA AVENUE, N.W., SUITE 800, WASHINGTON, DC, 20037, US

(73) Assignee: TOYOTA JIDOSHA KABUSHIKI KAISHA, Toyota-shi, Aichi-ken (JP)

(21) Appl. No.: 12/521,449

(22) PCT Filed: Oct. 25, 2007
(86) PCT No.: PCT/JP2007/070789

§ 371 Date: Jun. 26, 2009

(30) Foreign Application Priority Data
Dec. 28, 2006 (JP) 2006-356260

(51) Int. Cl. G06F 19/00; B60W 20/00

(52) U.S. Cl. 701/22; 701/111; 180/65.28

(57) ABSTRACT

In a hybrid vehicle 20, an engine 22, motors MG1 and MG2 are controlled so that vibration due to torque ripple arising in a crank shaft 26 is reduced by torque for a vibration control from the motor MG1 and torque demand Tr* is output to a ring gear shaft 32a when an ECO switch 88 is turned off during a start of an engine 22. When the ECO switch 88 is turned on during the start of an engine 22, the engine 22, motors MG1 and MG2 are controlled so that the torque for a vibration control from the motor MG1 becomes value “0” and the torque demand Tr* is output to the ring gear shaft 32a.

### TECHNICAL FIELD

The present invention relates to a vehicle and a control method thereof.

### BACKGROUND ART

Conventionally, there is proposed a hybrid vehicle having an engine and a first motor respectively connected to a planetary gear mechanism and a second motor connected to a drive shaft and capable of starting the engine through a cranking by the first motor (for example, refer to Patent Document 1). In the hybrid vehicle, the first motor is controlled to output torque for a vibration control that is in phase with torque ripple of an engine torque as a start of the engine, so that vibration due to the torque ripple may be prevented from being transmitted to the drive shaft.

### [Patent Document 1] Japanese Patent Laid-Open No. 2004-222439

### DISCLOSURE OF THE INVENTION

In the above hybrid vehicle, it may be possible to reduce the vibration due to the torque ripple at the start of the engine and the like. However, losses of the motor MG1 and the like may be increased when the motor MG1 outputs the torque for the vibration control, so that energy efficiency of the vehicle may be deteriorated. Further, some drivers may choose an improvement of fuel consumption even if the vibration is generated to some degree.

The present invention has an object to allow to freely select any one of a reduction of vibration of a vehicle attended with some deterioration in energy efficiency and an improvement of energy efficiency attended with slight vibration as a priority.

The present invention accomplishes the demand mentioned above by the following configurations applied to a vehicle and a control method thereof.

A vehicle according to the present invention is a vehicle including: an internal combustion engine capable of outputting power to a vehicle axle; a vibration control unit that executing a vibration control of reducing vibration due to torque ripple arising in an engine shaft of the internal combustion engine; an efficiency priority mode selection switch to select an efficiency priority mode that gives priority to energy efficiency; and a control module configured to control the vibration control unit so that the vibration due to the torque ripple arising in the engine shaft is reduced through the vibration control when the efficiency priority mode selection switch is turned off upon a satisfaction of a predetermined vibration reducing condition, the control module controlling the vibration control unit so that energy required for the vibration control is saved by decreasing an effect of the vibration control in comparison with the turn-off condition of the efficiency priority mode selection switch when the switch is turned on upon the satisfaction of the predetermined vibration reducing condition.

In the vehicle, it is possible to allow drivers and the like to freely select any one of a reduction of vibration of the vehicle attended with some deterioration in energy efficiency and an improvement of energy efficiency attended with slight vibration as a priority by only operating the efficiency priority mode selection switch.

The vibration control unit may be a rotating electric machine capable of supplying and receiving electric power from an accumulator and outputting torque for the vibration control to the engine shaft of the internal combustion engine. The control module may control the rotating electric machine so that the vibration due to the torque ripple arising in the engine shaft is reduced by the torque for the vibration control when the efficiency priority mode selection switch is turned off upon a satisfaction of a predetermined vibration reducing condition, and may control the rotating electric machine so that the torque for the vibration control is decreased in comparison with the turn-off condition of the efficiency priority mode selection switch when the switch is turned on upon the satisfaction of the predetermined vibration reducing condition. In the vehicle, the rotating electric machine is controlled so that the vibration due to the torque ripple arising in the engine shaft is reduced by the torque for the vibration control from the rotating electric machine when the efficiency priority mode selection switch is turned off upon a satisfaction of a predetermined vibration reducing condition. The rotating electric machine is also controlled so that the torque for the vibration control is decreased in comparison with the turn-off condition of the efficiency priority mode selection switch when the switch is turned on upon the satisfaction of the predetermined vibration reducing condition. Thus, when the efficiency priority mode selection switch is turned off, energy efficiency of the vehicle may be slightly deteriorated due to losses produced by an output of the torque for the vibration control from the rotating electric machine, however, it is possible to reduce vibration due to the torque ripple arising in the engine shaft. When the efficiency priority mode selection switch is turned on, slight vibration due to the torque ripple arising in the engine shaft is generated due to the decrease of the torque for the vibration control from the rotating electric machine, however, it is possible to reduce electric power consumption and losses of the rotating electric machine resulting from the output of the torque for the vibration control so as to improve energy efficiency of the vehicle.

The control module may control the rotating electric machine so that the torque for the vibration control is not output the engine shaft when the efficiency priority mode selection switch is turned on upon the satisfaction of the predetermined vibration reducing condition. Thus, when the efficiency priority mode selection switch is turned on, slight vibration due to the torque ripple arising in the engine shaft is generated due to a cancellation of the torque for the vibration control from the rotating electric machine, however, it is possible to eliminate electric power consumption and losses of the rotating electric machine resulting from the output of the torque for the vibration control so as to further improve energy efficiency of the vehicle.

The vibration reducing condition may be satisfied during at least one of a start of the internal combustion engine, an operation of the internal combustion engine, and a stop operation of stopping the operation of the internal combustion engine.

The rotating electric machine may be included in an electric power-mechanical power input output structure connected to the vehicle axle and the engine shaft of the internal combustion engine and outputting at least a part of power from the internal combustion engine to the axle side with input/output of electric power and mechanical power. In this case, the electric power-mechanical power input output structure may include a three shaft-type power input output assembly connected with three shafts, the vehicle axle, the engine shaft of the internal combustion engine, and a rotating shaft of the rotating electric machine, the three shaft-type power input output assembly configured to input and output power to one remaining shaft, based on input and output of powers from and to any two shafts selected among the three shafts. Further, the vehicle may further include a motor capable of receiving electric power from the accumulator and outputting power to the vehicle axle or another axle different from the vehicle axle.

A control method of a vehicle according to the present invention is a control method of a vehicle including an internal combustion engine capable of outputting power to a vehicle axle, a vibration control unit that executing a vibration control of reducing vibration due to torque ripple arising in an engine shaft of the internal combustion engine, and an efficiency priority mode selection switch to select an efficiency priority mode that gives priority to energy efficiency, the method including the step of:

(a) controlling the vibration control unit so that the vibration due to the torque ripple arising in the engine shaft is reduced through the vibration control when the efficiency priority mode selection switch is turned off upon a satisfaction of a predetermined vibration reducing condition, and controlling the vibration control unit so that energy required for the vibration control is saved by decreasing an effect of the vibration control in comparison with the turn-off condition of the efficiency priority mode selection switch when the switch is turned on upon the satisfaction of the predetermined vibration reducing condition.

According to the method, it is possible to allow drivers and the like to freely select any one of a reduction of vibration of the vehicle attended with some deterioration in energy efficiency and an improvement of energy efficiency attended with slight vibration as a priority by only operating the efficiency priority mode selection switch.

The vibration control unit may be a rotating electric machine capable of supplying and receiving electric power from an accumulator and outputting torque for the vibration control to the engine shaft of the internal combustion engine, and the step (a) may control the rotating electric machine so that the vibration due to the torque ripple arising in the engine shaft is reduced by the torque for the vibration control when the efficiency priority mode selection switch is turned off upon a satisfaction of a predetermined vibration reducing condition, and may control the rotating electric machine so that the torque for the vibration control is decreased in comparison with the turn-off condition of the efficiency priority mode selection switch when the switch is turned on upon the satisfaction of the predetermined vibration reducing condition. According to the method, when the efficiency priority mode selection switch is turned off, energy efficiency of the vehicle may be slightly deteriorated due to losses produced by an output of the torque for the vibration control from the rotating electric machine, however, it is possible to reduce vibration due to the torque ripple arising in the engine shaft. When the efficiency priority mode selection switch is turned on, slight vibration due to the torque ripple arising in the engine shaft is generated due to the decrease of the torque for the vibration control from the rotating electric machine, however, it is possible to reduce electric power consumption and losses of the rotating electric machine resulting from the output of the torque for the vibration control so as to improve energy efficiency of the vehicle.

The step (a) may control the rotating electric machine so that the torque for the vibration control is not output the engine shaft when the switch is turned on upon the satisfaction of the predetermined vibration reducing condition.

The vibration reducing condition may be satisfied during at least one of a start of the internal combustion engine, an operation of the internal combustion engine, and a stop operation of stopping the operation of the internal combustion engine.

The rotating electric machine may be included in an electric power-mechanical power input output structure connected to the vehicle axle and the engine shaft of the internal combustion engine and outputting at least a part of power from the internal combustion engine to the axle side with input/output of electric power and mechanical power. In this case, the electric power-mechanical power input output structure may include a three shaft-type power input output assembly connected with three shafts, the vehicle axle, the engine shaft of the internal combustion engine, and a rotating shaft of the rotating electric machine, the three shaft-type power input output assembly configured to input and output power to one remaining shaft, based on input and output of powers from and to any two shafts selected among the three shafts.

In the method, the vehicle may further include a motor capable of receiving electric power from the accumulator and outputting power to the vehicle axle or another axle different from the vehicle axle.

### BRIEF DESCRIPTION OF THE DRAWINGS

FIG. 1 is a schematic block diagram of a hybrid vehicle 20 according to an embodiment of the present invention;

FIG. 2 is a flowchart illustrating an example of an engine start drive control routine executed by a hybrid electric control unit 70 in the embodiment;

FIG. 3 is a view illustrating an example of a torque demand setting map;

FIG. 4 is a view illustrating an example of a cranking torque setting map;

FIG. 5 is a view illustrating an example of a vibration control torque setting map;

FIG. 6 is a view illustrating an alignment chart showing a dynamic relationship between a rotational speed and torque of each rotating element of a power distribution and integration mechanism 30;

FIG. 7 is a schematic block diagram of a hybrid vehicle 20A according to a modification of the present invention; and

FIG. 8 is a schematic block diagram of a hybrid vehicle 20B according to a further modification of the present invention.

### BEST MODES OF CARRYING OUT THE INVENTION

Now, the best mode for carrying out the present invention will be described with reference to an embodiment.

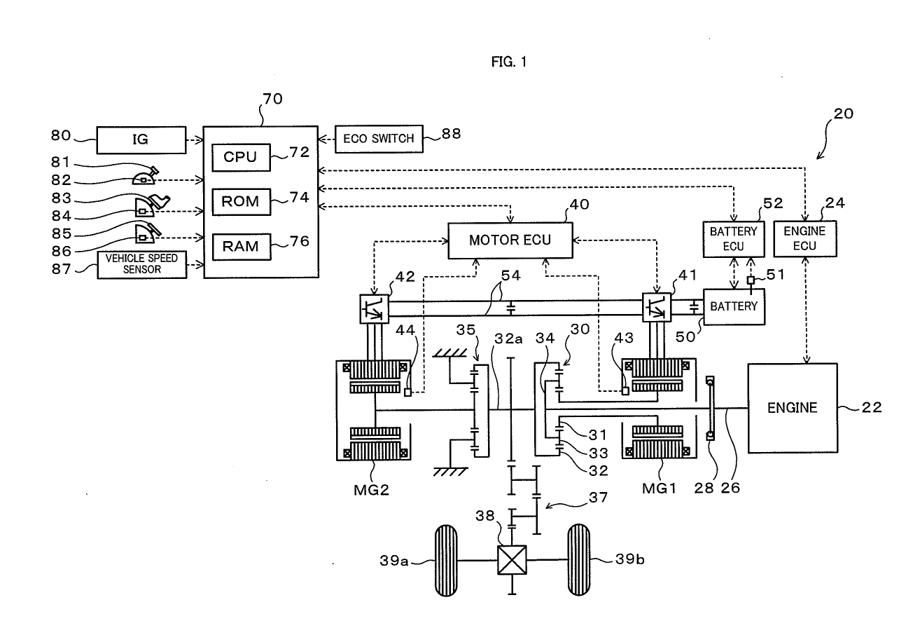

FIG. 1 schematically illustrates the configuration of a hybrid vehicle 20 in an embodiment of the invention. The hybrid vehicle 20 of the illustrated configuration includes an engine 22, a three shaft-type power distribution integration mechanism 30 connected via a damper 28 to a crankshaft 26 or an output shaft of the engine 22, a motor MG1 connected to the power distribution integration mechanism 30 and designed to have power generation capability, a reduction gear 35 attached to a ring gear shaft 32a as an axle connected to the power distribution integration mechanism 30, a motor MG2 connected to the ring gear shaft 32a via the reduction gear 35, and a hybrid electronic control unit 70 (hereinafter referred to as “hybrid ECU”) configured to control the operations of the whole hybrid vehicle 20.

The engine 22 is constructed as an internal combustion engine designed to consume a hydrocarbon fuel, such as gasoline or light oil, and thereby generate power. The engine 22 is under operation controls, such as fuel injection control, ignition timing control, and intake air flow control, of an engine electronic control unit 24 (hereinafter referred to as “engine ECU”). The engine ECU 24 inputs diverse signals from various sensors mounted on the engine 22 to measure and detect the operating conditions of the engine 22. The engine ECU 24 establishes communication with the hybrid ECU 70 to control the operations of the engine 22 in response to control signals from the hybrid ECU 70 and with reference to the diverse signals from the various sensors and to output data regarding the operating conditions of the engine 22 to the hybrid ECU 70 according to the requirements.

The power distribution integration mechanism 30 includes a sun gear 31 as an external gear, a ring gear 32 as an internal gear arranged concentrically with the sun gear 31, multiple pinion gears 33 arranged to engage with the sun gear 31 and with the ring gear 32, and a carrier 34 arranged to hold the multiple pinion gears 33 in such a manner as to allow both their revolutions and their rotations on their axes. The power distribution integration mechanism 30 is thus constructed as a planetary gear mechanism including the sun gear 31, the ring gear 32, and the carrier 34 as the rotational elements of differential motions. The carrier 34 as an engine-side rotational element, the sun gear 31, and the ring gear 32 as an axle-side rotational element in the power distribution integration mechanism 30 are respectively connected to the crankshaft 26 of the engine 22, to the motor MG1, and to the reduction gear 35 via the ring gear shaft 32a. When the motor MG1 functions as a generator, the power distribution integration mechanism 30 distributes the power of the engine 22 input via the carrier 34 into the sun gear 31 and the ring gear 32 corresponding to their gear ratio. When the motor MG1 functions as a motor, on the other hand, the power distribution integration mechanism 30 integrates the power of the engine 22 input via the carrier 34 with the power of the motor MG1 input via the sun gear 31 and outputs the integrated power to the ring gear 32. The power output to the ring gear 32 is transmitted from the ring gear shaft 32a through a gear mechanism 37 and a differential gear 38 and is eventually output to drive wheels 39a and 39b of the hybrid vehicle 20.

The motors MG1 and MG2 are constructed as known synchronous motor generators to enable operations as both a generator and a motor. The motors MG1 and MG2 receive and supply electric power to a battery 50 as a secondary cell via inverters 41 and 42. Power lines 54 connecting the battery 50 with the inverters 41 and 42 are structured as common positive bus and negative bus shared by the inverters 41 and 42. Such connection enables electric power generated by one of the motors MG1 and MG2 to be consumed by the other motor MG2 or MG1. The battery 50 may thus be charged with surplus electric power generated by either of the motors MG1 and MG2, while being discharged to supplement insufficient electric power. The battery 50 is neither charged nor discharged upon the balance of the input and output of electric powers between the motors MG1 and MG2. Both the motors MG1 and MG2 are driven and controlled by a motor electronic control unit 40 (hereinafter referred to as “motor ECU”). The motor ECU 40 inputs various signals required for driving and controlling the motors MG1 and MG2, for example, signals representing rotational positions of rotors in the motors MG1 and MG2 from rotational position detection sensors 43 and 44 and signals representing phase currents to be applied to the motors MG1 and MG2 from current sensors (not shown). The motor ECU 40 outputs switching control signals to the inverters 41 and 42. The motor ECU 40 also computes rotational speeds Nm1 and Nm2 of the rotors in the motors MG1 and MG2 according to a rotational speed computation routine (not shown) based on the output signals of the rotational position detection sensors 43 and 44. The motor ECU 40 establishes communication with the hybrid ECU 70 to drive and control the motors MG1 and MG2 in response to control signals received from the hybrid ECU 70 and to output data regarding the operating conditions of the motors MG1 and MG2 to the hybrid ECU 70 according to the requirements.

The battery 50 is under control and management of a battery electronic control unit 52 (hereinafter referred to as “battery ECU”). The battery ECU 52 inputs various signals required for management and control of the battery 50, for example, an inter-terminal voltage from a voltage sensor (not shown) located between terminals of the battery 50, a charge-discharge current from a current sensor (not shown) located in the power line 54 connecting with the output terminal of the battery 50, and a battery temperature Tb from a temperature sensor 51 attached to the battery 50. The battery ECU 52 outputs data regarding the operating conditions of the battery 50 by data communication to the hybrid ECU 70 and the engine ECU 24 according to the requirements. The battery ECU 52 also executes various arithmetic operations for management and control of the battery 50. A remaining capacity or state of charge SOC of the battery 50 is calculated from an integrated value of the charge-discharge current measured by the current sensor.

The hybrid ECU 70 is constructed as a microprocessor including a CPU 72, a ROM 74 configured to store processing programs, a RAM 76 configured to temporarily store data, input and output ports (not shown), and a communication port (not shown). The hybrid ECU 70 inputs, via its input port, an ignition signal from an ignition switch (start switch) 80, a shift position SP or a current setting position of a shift lever 81 from a shift position sensor 82, an accelerator opening Acc or the driver's depression amount of an accelerator pedal 83 from an accelerator pedal position sensor 84, a brake pedal stroke BS or the driver's depression amount of a brake pedal 85 from a brake pedal stroke sensor 86, and a vehicle speed V from a vehicle speed sensor 87. An ECO switch (efficiency priority mode selection switch) 88 to select, as a control mode at a time of driving, an ECO mode (efficiency priority mode selection) that gives priority to energy efficiency of the vehicle over a reduction of vibration in the vehicle is disposed in the vicinity of the driver's seat of the hybrid vehicle 20 of the present embodiment. The ECO switch 88 is also connected to the hybrid ECU 70. When the ECO switch 88 is turned on by the driver or the like, a predetermined ECO flag Feco that is set to value “0” during normal operation (when the ECO switch 88 is turned off) is set to value “1”, and the hybrid vehicle 20 is controlled according to various control procedures that are previously defined to give priority to efficiency. As described above, the hybrid ECU 70 is connected via the communication port with the engine ECU 24, the motor ECU 40, the battery ECU 52, and the like, and exchanges various control signals and data with the engine ECU 24, the motor ECU 40, the battery ECU 52, and the like.

The hybrid vehicle 20 of the embodiment constructed as described above sets a torque demand, which is to be output to the ring gear shaft 32a or the driveshaft linked with an axle of the hybrid vehicle 20, based on the vehicle speed V and the accelerator opening Acc corresponding to the driver's depression amount of the accelerator pedal 83, and controls the operations of the engine 22, the motors MG1 and MG2 to ensure output of power equivalent to the set torque demand to the ring gear shaft 32a. There are several drive control modes of the engine 22, the motors MG1 and MG2. In a torque conversion drive mode, while the engine 22 is driven and controlled to ensure output of the power equivalent to the torque demand, the motors MG1 and MG2 are driven and controlled to enable all the output power of the engine 22 to be subjected to torque conversion by the power distribution integration mechanism 30, the motors MG1 and MG2 and to be output to the ring gear shaft 32a. In a charge-discharge drive mode, the engine 22 is driven and controlled to ensure output of power corresponding to the sum of a power demand and electric power required for charging the battery 50 or electric power to be discharged from the battery 50. The motors MG1 and MG2 are driven and controlled to enable all or part of the output power of the engine 22 with charge or discharge of the battery 50 to be subjected to torque conversion by the power distribution integration mechanism 30, the motors MG1 and MG2 and to ensure output of the power demand to the ring gear shaft 32a. In a motor drive mode, the motor MG2 is driven and controlled to ensure output of power equivalent to the power demand to the ring gear shaft 32a, while the engine 22 stops its operation. Further, in the hybrid vehicle 20, an intermittent operation of the engine 22 is permitted when a predetermined intermittent permissive condition is satisfied. Accordingly, the hybrid vehicle 20 may be driven with power only from the motor MG2 while stopping an operation of the engine so as to improve fuel consumption.

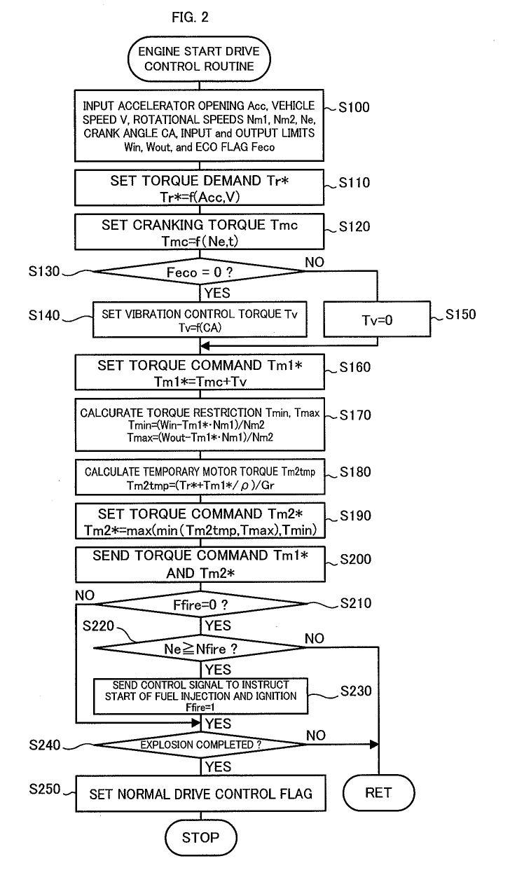

Next, the operation of starting the engine 22 of the hybrid vehicle 20 with the above configuration will be described. FIG. 2 is a flowchart illustrating an example of an engine start drive control routine that is executed by the hybrid ECU 70 at predetermined time intervals (for example, at ever several msec) during a stop of the hybrid vehicle 20, the intermittent operation of the engine 22 or the like.

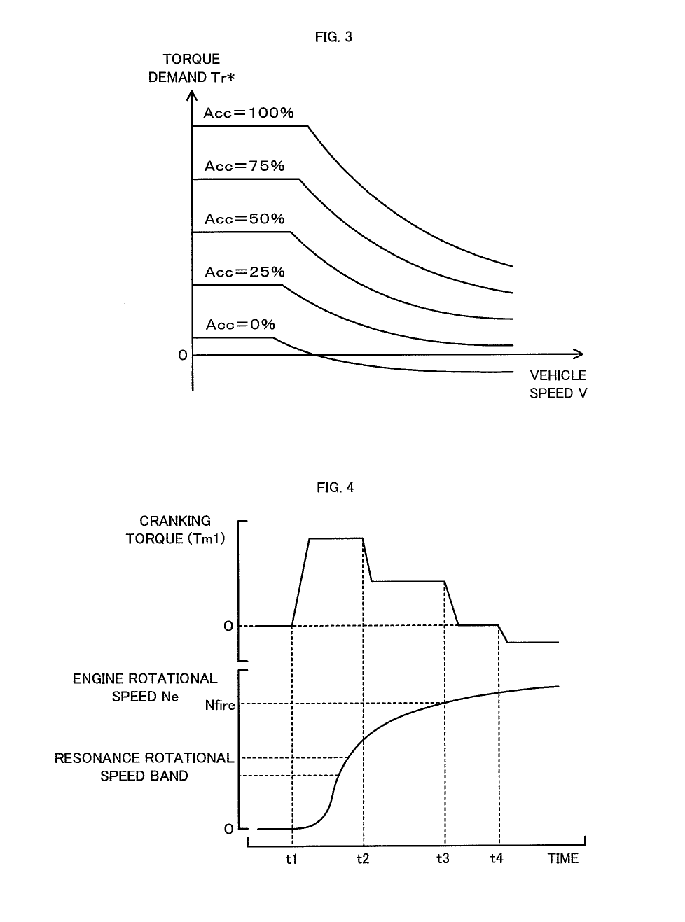

At start of the engine start drive control routine in FIG. 2, the CPU 72 of the hybrid ECU 70 executes input processing of data required for control such as the accelerator opening Acc from the accelerator pedal position sensor 84, the vehicle speed V from the vehicle speed sensor 87, the rotational speeds Nm1, Nm2 of the motors MG1, MG2, a rotational speed Ne of the engine 22, a crank angle CA, an input limit Win and an output limit Wout of the battery 50, and a value of the ECO flag Feco (Step S100). The rotational speeds Nm1 and Nm2 of the motors MG1 and MG2 are input from the motor ECU 40 by communication. The rotational speed Ne of the engine 22 and the crank angle CA are calculated based on a signal from a crank position sensor (not shown) mounted on the crank shaft 26 by the engine ECU 24 and are input from the engine ECU 24 by communication. The input limit Win and the output limit Wout are set based on the battery temperature Tb of the battery 50 and the state of charge SOC of the battery 50 and are input from the battery ECU 52 by communication. Then, the CPU 72 sets a torque demand Tr* to be output to the ring gear shaft 32a or the axle connected to drive wheels 39a and 39b based on the input accelerator opening Acc and the input vehicle speed V (Step S110). In the embodiment, the torque demand Tr* corresponding to the given accelerator opening Acc and the given vehicle speed V is derived from a torque demand setting map previously stored in the ROM 74 and defining a relationship between the accelerator opening Acc, the vehicle speed V and the torque demand Tr*. FIG. 3 illustrates an example of the torque demand setting map.

Then, the CPU 72 sets a cranking torque Tmc for cranking the engine 22 by the motor MG1 to start the engine 22 based on the input rotational speed Ne of the engine 22 and an elapsed time t from the start of the routine counted by a timer that is not illustrated in the drawings (Step S120). In the embodiment, the cranking torque Tmc corresponding to the given rotational speed Ne and the elapsed time t is derived from a cranking torque setting map previously stored in the ROM 74 and defining a relationship between the cranking torque Tmc, the rotational speed Ne of the engine 22, and the elapsed time t. FIG. 4 illustrates an example of the cranking torque setting map. According to the cranking torque setting map, as seen from FIG. 4, relative large torque is set as the cranking torque based on a rate processing just after a start time t1 of a cranking in order to promptly increase the rotational speed Ne of the engine 22. At a time t2 when the rotational speed Ne of the engine 22 passes a resonance rotational speed band or a time required for passing the resonance rotational speed band is elapsed, the cranking torque is set to torque capable of stably cranking the engine 22 at rotational speed more than an ignition start rotational speed Nfire so as to decrease electric power consumption and a reaction force output to the ring gear shaft 32a as the axle by the motor MG1. From a time t3 when the rotational speed Ne reaches the ignition start rotational speed Nfire, the CPU 72 gradually decreases the cranking torque up to value “0” based on a rate processing. From a time t4 when determined that an explosion of the engine 22 is completed, torque for power generation is set as a torque command Tm1* for the motor.

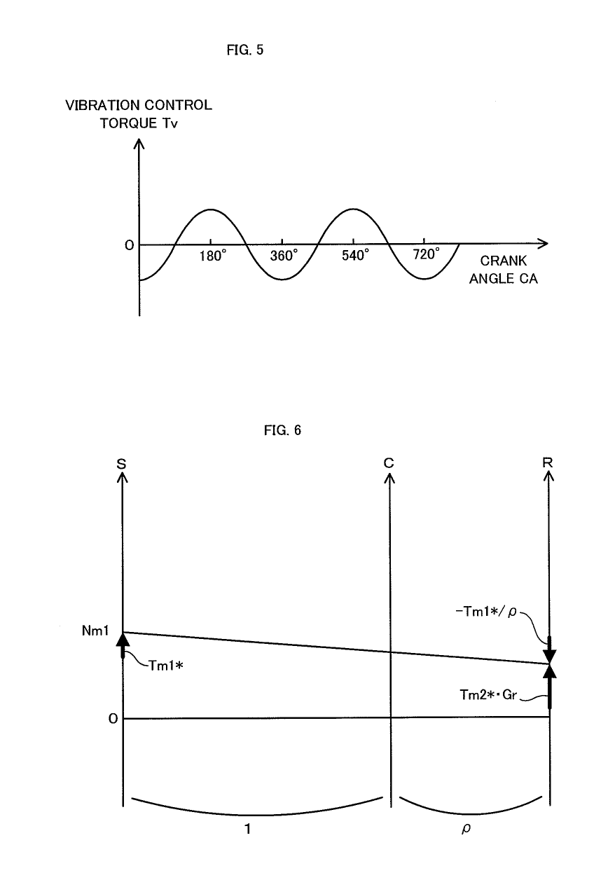

After setting the cranking torque Tmc, the CPU 72 determines whether or not the input ECO flag Feco is value “0”, that is, whether or not the ECO switch 88 is turned off by the driver or the like (Step S130). When the ECO switch 88 is turned off and the value of the ECO flag Feco is value “0”, the CPU 72 sets a vibration control torque (torque for a vibration control) Tv based on the crank angle CA input at Step S100 (Step S140). The vibration control torque Tv is torque output by the motor MG1 so as to prevent torque ripple arising in the crank shaft 26 during the cranking of the engine 22 from being transmitted to the ring gear shaft 32a or the axle. In the embodiment, the vibration control torque is defined as torque having opposite phase to the torque ripple that arises in the crank shaft 26 during the cranking of the engine 22 and is previously acquired with respect to the crank angle CA through experiments and analyses. The vibration control torque TV corresponding to the given crank angle CA is derived from a vibration control torque setting map stored in the ROM 74 and defining a relationship between the vibration control torque Tv and the crank angle CA to reduce vibration due to the torque ripple under normal condition where the ECO switch 88 is turned off. FIG. 5 illustrates an example of the vibration control torque setting map. On the other hand, the vibration control torque Tv is set to value “0” when the ECO switch 88 is turned on and the value of the ECO flag Feco is value “1” (Step S150). That is, when the ECO switch 88 is turned on in the embodiment, the vibration control is not performed to prevent torque ripple arising in the crank shaft 26 during the cranking of the engine 22 from being transmitted to the ring gear shaft 32a or the axle even though vibration due to the torque ripple is to be preferably reduced during the start of the engine 22. After setting the vibration control torque Tv at Step S140 or S150, the CPU 72 sets the torque command Tm1* to the sum of the cranking torque Tmc set at Step S120 and the vibration control torque Tv set at Step S140 or S150 (Step S160). By setting the torque command Tm1* as described above, it is possible to prevent the torque ripple arising during the cranking of the engine 22 from being transmitted to the ring gear shaft 32a or the axle and reduce vibration of the hybrid vehicle 20 when the ECO switch 88 is turned off.

After setting the torque command Tm1*, the CPU 72 calculates a lower torque restriction Tmin and an upper torque restriction Tmax as allowable minimum and maximum torques to be output from the motor MG2 according to the following equations (1) and (2) by dividing a deviation between the output limit Wout or the input limit Win of the battery 50 and power consumption (generated electric power) of the motor MG1 that is a product of the torque command Tm1* and the current rotational speed Nm1 of the motor MG1 by the rotational speed Nm2 of the motor MG2 (Step S170). Further, the CPU 72 calculates a temporary motor torque Tm2tmp as a torque value to be output from the motor MG2, based on the torque demand Tr*, the torque command Tm1*, the gear ratio ρ of the power distribution integration mechanism 30, and the gear ratio Gr of the reduction gear 35 according to Equation (3) given below (Step S180). Then, the CPU 72 sets a torque command Tm2* of the motor MG2 to a value obtained by limiting the calculated temporary motor torque Tm2tmp by the lower and the upper torque restrictions Tmin and Tmax (Step S190). Equation (3) used at Step S180 is readily introduced from the alignment chart of FIG. 6. FIG. 6 illustrates an alignment chart showing torque-rotational speed dynamics of the respective rotational elements included in the power distribution integration mechanism 30 at the cranking to start the engine 22. In FIG. 6, the left axis ‘S’ represents a rotational speed of the sun gear 31 that is equivalent to the rotational speed Nm1 of the motor MG1, the middle axis ‘C’ represents a rotational speed of the carrier 34 that is equivalent to the rotational speed Ne of the engine 22, and the right axis ‘R’ represents the rotational speed Nr of the ring gear 32 obtained by dividing the rotational speed Nm2 of the motor MG2 by the gear ratio Gr of the reduction gear 35. Two thick arrows on the axis ‘R’ respectively show torque applied to the ring gear shaft 32a by the cranking of the engine 22, and torque applied to the ring gear shaft 32a via the reduction gear 35 by the motor MG2 so as to cancel the torque by the cranking and ensure the torque demand Tr*. Setting the torque command Tm2* of the motor MG2 in such a manner may restrict the torque command Tm2* for cancelling the torque (torque=−1/ρ·Tm1* in FIG. 6) as a reaction force with respect to a driving force applied to the ring gear shaft 32a according to torque for cranking the engine 22 (torque command Tm1* of the motor MG1) and outputting the torque demand Tr* to the ring gear shaft 32a within the range of the input limit Win and the output limit Wout of the battery 50. Then, the CPU 72 sends the set torque command Tm1* and Tm2* to the motor ECU 40 (Step S200). The motor ECU 40 receives the torque commands Tm1* and Tm2* and performs switching control of switching elements included in the respective inverters 41 and 42 so that the motor MG1 is driven in accordance with the torque command Tm1* and the motor MG2 is driven in accordance with the torque command Tm2*.

Tmax=(Wout−Tm1*·Nm1)/Nm2 (1)

Tmin=(Win−Tm1*·Nm1)/Nm2 (2)

Tm2tmp=(Tr*+Tm1*/ρ)/Gr (3)

Then, the CPU 72 determines whether or not a fuel injection start flag Ffire is value “0” (Step S210). The fuel injection start flag Ffire is set to value “0” until a fuel injection and an ignition control are started and is set to value “1” when the fuel injection and the ignition control are started. When the fuel injection start flag Ffire is value “0”, the CPU 72 further determines whether or not the rotational speed Ne of the engine 22 reaches a ignition start rotational speed Nfire (Step S220). The ignition start rotational speed Nfire is a rotational speed at a start of the fuel injection and the ignition control and is predetermined to 1000-1200 rpm for example. When the rotational speed Ne of the engine 22 does not reach the ignition start rotational speed Nfire, the CPU 72 repeatedly executes the processing from Step S100 to S210. When the rotational speed Ne of the engine 22 reaches the ignition start rotational speed Nfire, the CPU 72 send a control signal to instruct the start of the fuel injection and the ignition control to the engine ECU 24 and sets the fuel injection start flag Ffire to value “1” (Step S230). Then, the CPU 72 determines whether or not an explosion of the engine 22 is completed (Step S240). When the explosion of the engine 22 is not completed, the CPU 72 executes the processing of and after Step S100. Once the fuel injection start flag Ffire is set to value “1” at Step S230, the CPU 72 determines that the fuel injection start flag Ffire is value “1” and skips the comparison processing of Steps S220 and S230. Then, the CPU 72 determines whether or not the explosion of the engine 22 is completed (Step S240). When the explosion of the engine 22 is completed, the CPU 72 sets a normal drive control flag (Step S250) and terminates the routine. When the normal drive control flag is set, the CPU 72 executes a drive control routine for a normal operation (not shown).

As has been described above, in the hybrid vehicle 20, the engine 22, motors MG1 and MG2 are controlled so that the vibration due to the torque ripple arising in the crank shaft 26 is reduced by the vibration control torque Tv from the motor MG1 and torque equivalent to the torque demand Tr* is output to the ring gear shaft 32a or the axle when the ECO switch 88 or the efficiency priority mode selection switch is turned off upon the start of the engine 22 in which the vibration due to the torque ripple that arises during the cranking of the engine 22 is preferably reduced (Steps S140-S250). On the other hand, the engine 22, motors MG1 and MG2 are controlled so that the vibration control torque Tv is decreased in comparison with the turn-off condition of the ECO switch 88 so as to be value “0” and torque equivalent to the torque demand Tr* is output to the ring gear shaft 32a when the ECO switch 88 is turned on upon the start of the engine 22 in which the vibration due to the torque ripple that arises during the cranking of the engine 22 is preferably reduced (Steps S150-S250). Thus, when the ECO switch 88 is turned off upon the start of the engine 22, energy efficiency of the hybrid vehicle 20 may be slightly deteriorated due to losses produced by the output of the vibration control torque Tv from the motor MG1, however, it is possible to reduce vibration due to the torque ripple arising in the crank shaft 26. When the ECO switch 88 is turned on, slight vibration due to the torque ripple arising in the crank shaft 26 is generated due to the decrease of the vibration control torque Tv from the motor MG1, however, it is possible to reduce electric power consumption and losses of the motor MG1 resulting from the output of the vibration control torque Tv so as to improve energy efficiency of the vehicle. Accordingly, in the vehicle, it is possible to allow drivers and the like to freely select any one of the reduction of vibration of the vehicle attended with some deterioration in energy efficiency and the improvement of energy efficiency attended with slight vibration as a priority by only operating the ECO switch 88. In the hybrid vehicle 20, the engine 22, motors MG1 and MG2 are controlled so that equivalent to the torque demand Tr* is output to the ring gear shaft 32a without the output of the vibration control torque from the motor MG1 (vibration control torque=0) when the ECO switch 88 is turned on. Accordingly, it is possible to eliminate electric power consumption and losses of the motor MG1 resulting from the output of the vibration control torque Tv so as to further improve energy efficiency of the vehicle since the vibration control torque is not outputted from the motor MG1. However, the present invention is not limited to thereto. In stead of setting the vibration control torque Tv to value “0”, the vibration control torque may be decreased by a predetermined amount in comparison with the turn-off condition of the ECO switch 88 when it is turned on.

In the hybrid vehicle 20, the vibration control may be executed during the driving with an operation of the engine 22, an stop operation of stopping the operation of the engine 22 due to the intermittent operation so as to prevent torque ripple arising in the crank shaft 26 of the engine 22 from being transmitted to the ring gear shaft 32a or the axle by predetermining relationships between the vibration control torque and the crank angle CA regarding various operational conditions. Accordingly, the engine 22, motors MG1 and MG2 may be controlled so that the vibration due to the torque ripple arising in the crank shaft 26 is reduced by the vibration control torque Tv from the motor MG1 and torque equivalent to the torque demand Tr* is output to the ring gear shaft 32a or the axle when the ECO switch 88 is turned off upon the driving with the operation of the engine 22 and the stop operation of the engine 22. Also, the engine 22, motors MG1 and MG2 may be controlled so that the vibration control torque Tv is decreased in comparison with the turn-off condition of the ECO switch 88 or is set to value “0” and torque equivalent to the torque demand Tr* is output to the ring gear shaft 32a when the ECO switch 88 is turned on upon the driving with the operation of the engine 22 and the stop operation of the engine 22.

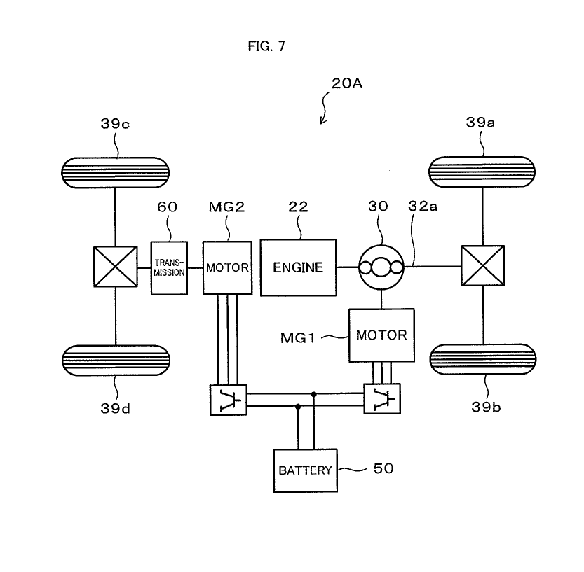

The present invention can be naturally applied to a conventional vehicle that does not include a motor and the like capable of outputting power for driving. In such a case, the torque for the vibration control may be output by a starter or an alternator capable of cranking the engine 22. Further, in vehicles capable of disconnecting the engine from the axle side and automatically stopping the engine upon a deceleration driving for example, the present invention may be advantageously applied during an automatic stop operation and a restart of the engine. Although the hybrid vehicle 20 of the above described embodiment is a vehicle that outputs the power of the motor MG2 to an axle connected to the ring gear shaft 32a, an object for application of the present invention is not limited thereto. More specifically, as in the case of a hybrid vehicle 20A as a modification example shown in FIG. 7, the present invention may also be applied to a vehicle in which the power of the motor MG2 is output to an axle (axle connected to wheels 39c and 39d in FIG. 7) that is different from the axle (axle to which the wheels 39a and 39b are connected) that is connected to the ring gear shaft 32a.

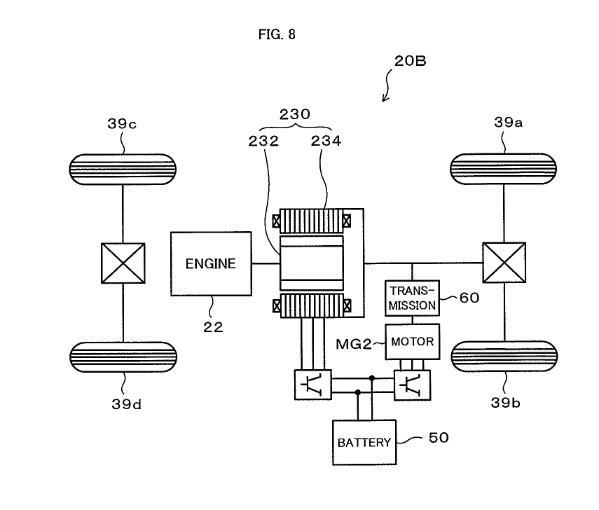

Further, although the hybrid vehicle 20 of the above described embodiment is a vehicle that outputs the power of the engine 22 to the ring gear shaft 32a as an axle connected to the wheels 39a and 39b via the power distribution and integration mechanism 30, an object for application of the present invention is not limited thereto. More specifically, as in the case of a hybrid vehicle 20B as a modification example shown in FIG. 8, the present invention may also be applied to a vehicle that includes a pair-rotor motor 230 that has an inner rotor 232 connected to the crankshaft of the engine 22, and an outer rotor 234 connected to the axle that outputs the power to the wheels 39a and 39b and that transmits a part of the power output from the engine 22 to the axle while converting the remainder of the power into electric power.

The correlation between the principal elements of the embodiments and modification examples, and the principal elements of the invention described in the “Disclosure of the Invention” section will now be described. That is, the engine 22 capable of outputting power to the ring gear shaft 32a and the like corresponds to “internal combustion engine”, the motor MG1 and the pair-rotor motor 230 corresponds to “rotating electric machine”, the battery 50 corresponds to “accumulator”, the ECO switch 88 to select the ECO mode giving priority to energy efficiency of the vehicle over a reduction of vibration in the vehicle corresponds to “efficiency priority mode selection switch”, the hybrid ECU 70 and the like executing the drive control routine shown in FIG. 2 corresponds to “control module”, a combination of the motor MG1 and the power distribution integration mechanism 30, and the pair-rotor motor 230 corresponds to “vibration control unit” and “electric power-mechanical power input output structure”, the power distribution integration mechanism 30 corresponds to “three shaft-type power input output assembly”, and the motor MG2 corresponds to “motor. In any case, the correspondence between the main elements in the embodiment and the variant and the main elements in the invention described in “Disclosure of the Invention” do not limit the elements in the invention described in “Disclosure of the Invention” since the embodiment is an example for describing in detail the best mode for carrying out the invention described in “Disclosure of the Invention”. Specifically, the embodiment is merely a detailed example of the invention described in “Disclosure of the Invention”, and the invention described in “Disclosure of the Invention” should be construed on the basis of the description therein.

Hereinbefore, the embodiments of the present invention have been described with reference to drawings, however, the present invention is not limited to the above embodiments. It will be apparent that various modifications can be made to the present invention without departing from the spirit and scope of the present invention.

### INDUSTRIAL APPLICABILITY

The technique of the invention is preferably applied to the manufacturing industries of vehicles.

1. A vehicle comprising:
an internal combustion engine capable of outputting power to a vehicle axle;
a vibration control unit that executing a vibration control of reducing vibration due to torque ripple arising in an engine shaft of the internal combustion engine;
an efficiency priority mode selection switch to select an efficiency priority mode that gives priority to energy efficiency; and
a control module configured to control the vibration control unit so that the vibration due to the torque ripple arising in the engine shaft is reduced through the vibration control when the efficiency priority mode selection switch is turned off upon a satisfaction of a predetermined vibration reducing condition, the control module controlling the vibration control unit so that energy required for the vibration control is saved by decreasing an effect of the vibration control in comparison with the turn-off condition of the efficiency priority mode selection switch when the switch is turned on upon the satisfaction of the predetermined vibration reducing condition.

2. A vehicle according to claim 1, wherein the vibration control unit is a rotating electric machine capable of supplying and receiving electric power from an accumulator and outputting torque for the vibration control to the engine shaft of the internal combustion engine, and wherein the control module controls the rotating electric machine so that the vibration due to the torque ripple arising in the engine shaft is reduced by the torque for the vibration control when the efficiency priority mode selection switch is turned off upon a satisfaction of a predetermined vibration reducing condition, and controls the rotating electric machine so that the torque for the vibration control is decreased in comparison with the turn-off condition of the efficiency priority mode selection switch when the switch is turned on upon the satisfaction of the predetermined vibration reducing condition.

3. A vehicle according to claim 2, wherein the control module controls the rotating electric machine so that the torque for the vibration control is not output the engine shaft when the efficiency priority mode selection switch is turned on upon the satisfaction of the predetermined vibration reducing condition.

4. A vehicle according to claim 1, wherein the vibration reducing condition is satisfied during at least one of a start of the internal combustion engine, an operation of the internal combustion engine, and a stop operation of stopping the operation of the internal combustion engine.

5. A vehicle according to claim 2, wherein the rotating electric machine is included in an electric power-mechanical power input output structure connected to the vehicle axle and the engine shaft of the internal combustion engine and outputting at least a part of power from the internal combustion engine to the axle side with input/output of electric power and mechanical power.

6. A vehicle according to claim 5, wherein the electric power-mechanical power input output structure includes a three shaft-type power input output assembly connected with three shafts, the vehicle axle, the engine shaft of the internal combustion engine, and a rotating shaft of the rotating electric machine, the three shaft-type power input output assembly configured to input and output power to one remaining shaft, based on input and output of powers from and to any two shafts selected among the three shafts.

7. A vehicle according to claim 2, further comprising a motor capable of receiving electric power from the accumulator and outputting power to the vehicle axle or another axle different from the vehicle axle.

8. A control method of a vehicle including an internal combustion engine capable of outputting power to a vehicle axle, a vibration control unit that executing a vibration control of reducing vibration due to torque ripple arising in an engine shaft of the internal combustion engine, and an efficiency priority mode selection switch to select an efficiency priority mode that gives priority to energy efficiency, the method comprising the step of:
(a) controlling the vibration control unit so that the vibration due to the torque ripple arising in the engine shaft is reduced through the vibration control when the efficiency priority mode selection switch is turned off upon a satisfaction of a predetermined vibration reducing condition, and controlling the vibration control unit so that energy required for the vibration control is saved by decreasing an effect of the vibration control in comparison with the turn-off condition of the efficiency priority mode selection switch when the switch is turned on upon the satisfaction of the predetermined vibration reducing condition.

9. A control method of a vehicle according to claim 8, wherein the vibration control unit is a rotating electric machine capable of supplying and receiving electric power from an accumulator and outputting torque for the vibration control to the engine shaft of the internal combustion engine, and the step (a) controls the rotating electric machine so that the vibration due to the torque ripple arising in the engine shaft is reduced by the torque for the vibration control when the efficiency priority mode selection switch is turned off upon a satisfaction of a predetermined vibration reducing condition, and controls the rotating electric machine so that the torque for the vibration control is decreased in comparison with the turn-off condition of the efficiency priority mode selection switch when the switch is turned on upon the satisfaction of the predetermined vibration reducing condition.

10. A control method of a vehicle according to claim 9, wherein the step (a) controls the rotating electric machine so that the torque for the vibration control is not output the engine shaft when the switch is turned on upon the satisfaction of the predetermined vibration reducing condition.

11. A control method of a vehicle according to claim 8, wherein the vibration reducing condition is satisfied during at least one of a start of the internal combustion engine, an operation of the internal combustion engine, and a stop operation of stopping the operation of the internal combustion engine.

12. A control method of a vehicle according to claim 9, wherein the rotating electric machine is included in an electric power-mechanical power input output structure connected to the vehicle axle and the engine shaft of the internal combustion engine and outputting at least a part of power from the internal combustion engine to the axle side with input/output of electric power and mechanical power.

13. A control method of a vehicle according to claim 12, wherein the electric power-mechanical power input output structure includes a three shaft-type power input output assembly connected with three shafts, the vehicle axle, the engine shaft of the internal combustion engine, and a rotating shaft of the rotating electric machine, the three shaft-type power input output assembly configured to input and output power to one remaining shaft, based on input and output of powers from and to any two shafts selected among the three shafts.

14. A control method of a vehicle according to claim 8, wherein the vehicle further includes a motor capable of receiving electric power from the accumulator and outputting power to the vehicle axle or another axle different from the vehicle axle.
